(19) United States
(12) Patent Application Publication
(10) Pub. No.: US 2017/0286523 A1
(43) Pub. Date: Oct. 5, 2017

(54) APPARATUS AND METHOD FOR VERIFYING CLOUD SERVICE COMPATIBILITY

(71) Applicant: ELECTRONICS AND TELECOMMUNICATIONS RESEARCH INSTITUTE, Daejeon (KR)

(72) Inventor: Kang-Chan LEE, Daejeon (KR)

(73) Assignee: ELECTRONICS AND TELECOMMUNICATIONS RESEARCH INSTITUTE, Daejeon (KR)

(21) Appl. No.: 15/465,860

(22) Filed: Mar. 22, 2017

(30) Foreign Application Priority Data
Mar. 29, 2016 (KR) 10-2016-0037504
Jul. 26, 2016 (KR) 10-2016-0094865

(51) Int. Cl. G06F 17/30; H04L 29/08

(52) U.S. Cl. CPC G06F 17/30598; G06F 17/30569; G06F 17/30917; G06F 17/30292; H04L 67/16; H04L 67/10

(57) ABSTRACT

Disclosed herein are an apparatus and method for verifying cloud service compatibility. The apparatus includes a cloud service description management unit, a cloud service relationship analysis unit, a schema mapping information management unit, an interoperability verification unit, and a data portability verification unit. By means of this configuration, a cloud service description for a cloud service is generated, and interoperability and portability are examined based on data about the cloud service description. Further, the apparatus and method determine whether cloud service compatibility, which includes cloud interoperability, and data and application portability for supporting semantic and syntactic models, is present among interoperability models, data portability models, and application portability models of cloud computing, which are presented in a standard document, and thus the results of the determination are provided.

### CROSS REFERENCE TO RELATED APPLICATIONS

This application claims the benefit of Korean Patent Application Nos. 10-2016-0037504, filed Mar. 29, 2016 and 10-2016-0094865, filed Jul. 26, 2016, which are hereby incorporated by reference in their entirety into this application.

### BACKGROUND OF THE INVENTION

### 1. Technical Field

The present invention relates generally to an apparatus and method for verifying compatibility between cloud services and, more particularly, to an apparatus and method that verify whether semantic interoperability, syntactic interoperability, semantic portability and syntactic portability are present, among various types of interoperability and portability relevant to cloud computing, using cloud service descriptions.

### 2. Description of the Related Art

The term “cloud computing” denotes computing that provides virtualized Information Technology (IT) resources in the form of service using Internet technology. A user may lease and use as many IT resources (e.g. application service, software, storage, a server, a network, etc.) as needed, and may be provided with real-time scalability that responds to a service load.

That is, cloud computing is an Internet protocol-based IT service provision model, which allows an IT service user to be provided with IT service over the Internet whenever and wherever he or she needs the IT service regardless of the physical location and configuration of the system that provides cloud service.

Current cloud service providers provide services using different types of schemes, which results in a problem in that interoperability and portability between different cloud services are not secured.

If such interoperability and portability are not secured, a user encounters a situation in which excessive expenses, transfer times, etc. are consumed when the user desires to transfer a received cloud service from the current cloud service provider to another cloud service provider.

This situation entails a vender lock-in phenomenon of being bound to a vendor that is a cloud service provider, thus acting as an obstacle to the introduction of cloud services to enterprises.

Therefore, when the interoperability or portability of cloud computing is guaranteed, the user may conveniently switch cloud service providers or easily change a cloud model without incurring additional high expenses or burdensome task procedures. Accordingly, the need to guarantee interoperability or portability has gradually increased.

### SUMMARY OF THE INVENTION

Accordingly, the present invention has been made keeping in mind the above problems occurring in the prior art, and an object of the present invention is to provide an apparatus and method for verifying cloud service compatibility, which generate a cloud service description related to a cloud service and examine interoperability and portability based on data about the cloud service description, so that it is determined whether cloud service compatibility, which includes cloud interoperability, and data and application portability for supporting semantic and syntactic models, is present among interoperability models, data portability models, and application portability models of cloud computing, which are presented in a standard document, and thus the results of the determination are provided.

In accordance with an aspect of the present invention to accomplish the above object, there is provided an apparatus for verifying cloud service compatibility, including a cloud service description management unit for generating or updating service description information by acquiring a cloud service description from at least one cloud service and by parsing the acquired cloud service description; a cloud service relationship analysis unit for generating cloud service associative relationship information by searching for one or more cloud services that use a cloud service description included in the service description information and by grouping the found one or more cloud services; a schema mapping information management unit for managing a user-defined function to be used for verification of data portability, generating schema mapping information that includes corresponding relationships between respective components constituting each schema using data about the user-defined function, and converting data included in the service description information in consideration of the user-defined function and the schema mapping information; an interoperability verification unit for determining whether the one or more cloud services are interoperable with each other based on the cloud service associative relationship information and converted schema data; and a data portability verification unit for determining whether pieces of data are mutually portable between the one or more cloud services based on the cloud service associative relationship information and the converted schema data.

The cloud service description management unit may include a service description parsing unit for parsing a cloud service description provided in at least one data format; a service description examination unit for examining the parsed cloud service description for syntax of a service description language; and a service description information generation unit for generating or managing service description information that includes information about the parsed cloud service description and information about results of the service description examination.

The cloud service relationship analysis unit may include a cloud service description search unit for searching for a cloud service description having a format identical to that of the cloud service description included in the service description information; and a cloud service associative relationship information generation unit for searching for one or more cloud services that use the found cloud service description, and generating cloud service associative relationship information indicative of associative relationships between the cloud service description and the found one or more cloud services by grouping the one or more cloud services.

The cloud service associative relationship information generation unit may further include a cloud service recommendation unit for providing information about items and details of interoperable or data-portable cloud services to cloud services that match the acquired service description information based on the cloud service associative relationship information.

The cloud service associative relationship information generation unit may include information about items and details of cloud services having a parent or child relationship therebetween in the cloud service associative relationship information.

The schema mapping information management unit may include a user-defined function management unit for managing the user-defined function by storing, changing or deleting a user-defined function used for examination between data models to verify data portability; a schema mapping information generation unit for generating mapping information that includes corresponding relationships between respective components constituting each schema based on the user-defined function; an integrated schema management unit for integrating a schema of corresponding data based on the schema mapping information, and managing the schema by storing, searching for or changing the integrated data; and a data conversion unit for converting the schema of the corresponding data in consideration of the user-defined function and the schema mapping information.

The interoperability verification unit may include a syntactic interoperability verification unit for determining whether respective Application Programming Interfaces (APIs) of the cloud services are identical to each other at an API level by analyzing the service description information based on the cloud service associative relationship information and the converted schema data, thus verifying interoperability between the cloud services; and a semantic interoperability verification unit for verifying whether pieces of data, which are provided for respective domains in an infrastructure, a platform, and software of an Infrastructure as a Service (IaaS), a Platform as a Service (PaaS), and Software as a Service (SaaS), are interoperable with each other, based on the cloud service associative relationship information and the converted schema data.

The data portability verification unit may include a syntactic data portability verification unit for verifying whether the data formats of the one or more cloud services are mutually portable, based on the cloud service associative relationship information and the converted schema data; a semantic data portability verification unit for verifying whether cloud service data models of the one or more cloud services are mutually portable, based on the cloud service associative relationship information and the converted schema data; and an application data portability verification unit for verifying whether pieces of metadata about applications used in the one or more cloud services are mutually portable, based on the cloud service associative relationship information and the converted schema data.

The apparatus may further include a cloud service description database for storing or updating the acquired cloud service description and the service description information.

The apparatus may further include a schema database for storing or updating the user-defined function and the schema mapping information.

The cloud service description may include a service description name, a category, a node location, an interface, a service, resource, binding information, a port, a programming language, price, a description, a service description creation date, service description version information, and a parent or child service name.

In accordance with another aspect of the present invention to accomplish the above object, there is provided a method for verifying cloud service compatibility, including generating or updating service description information by acquiring a cloud service description from at least one cloud service and by parsing the acquired cloud service description; generating cloud service associative relationship information by searching for one or more cloud services that use a cloud service description included in the service description information and by grouping the found one or more cloud services; managing a user-defined function to be used for verification of data portability, generating schema mapping information that includes corresponding relationships between respective components constituting each schema using data about the user-defined function, and converting data included in the service description information in consideration of the user-defined function and the schema mapping information; determining whether the one or more cloud services are interoperable with each other based on the cloud service associative relationship information and converted schema data; and determining whether pieces of data are mutually portable between the one or more cloud services based on the cloud service associative relationship information and the converted schema data.

Generating or updating the service description information may include parsing a cloud service description provided in at least one data format; examining the parsed cloud service description for syntax of a service description language; and generating or managing service description information that includes information about the parsed cloud service description and information about results of the service description examination.

Generating the cloud service associative relationship information may include searching for a cloud service description having a format identical to that of the cloud service description included in the service description information; and searching for one or more cloud services that use the found cloud service description, and then generating cloud service associative relationship information indicative of associative relationships between the cloud service description and the found one or more cloud services by grouping the one or more cloud services.

Generating the cloud service associative relationship information may further include providing information about items and details of interoperable or data-portable cloud services to cloud services that match the acquired service description information based on the cloud service associative relationship information.

Generating the cloud service associative relationship information may be configured to include information about items and details of cloud services having a parent or child relationship therebetween in the cloud service associative relationship information.

Converting the data included in the service description information may include managing the user-defined function by storing, changing or deleting a user-defined function used for examination between data models to verify data portability; generating mapping information that includes corresponding relationships between respective components constituting each schema based on the user-defined function; integrating a schema of corresponding data based on the schema mapping information, and managing the schema by storing, searching for or changing the integrated data; and converting the schema of the corresponding data in consideration of the user-defined function and the schema mapping information.

Determining whether the one or more cloud services are interoperable with each other may include determining whether respective Application Programming Interfaces (APIs) of the cloud services are identical to each other at an API level by analyzing the service description information based on the cloud service associative relationship information and the converted schema data, thus verifying interoperability between the cloud services; and verifying whether pieces of data, which are provided for respective domains in an infrastructure, a platform, and software of an Infrastructure as a Service (IaaS), a Platform as a Service (PaaS), and Software as a Service (SaaS), are interoperable with each other, based on the cloud service associative relationship information and the converted schema data.

Determining whether the pieces of data are mutually portable may include verifying whether the data formats of the one or more cloud services are mutually portable, based on the cloud service associative relationship information and the converted schema data; verifying whether cloud service data models of the one or more cloud services are mutually portable, based on the cloud service associative relationship information and the converted schema data; and verifying whether pieces of metadata about applications used in the one or more cloud services are mutually portable, based on the cloud service associative relationship information and the converted schema data.

The method may further include storing or updating the acquired cloud service description and the service description information.

The method may further include storing or updating the user-defined function and the schema mapping information.

The cloud service description may include a service description name, a category, a node location, an interface, a service, resource, binding information, a port, a programming language, price, a description, a service description creation date, service description version information, and a parent or child service name.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating connection relationships between cloud service providers and cloud service customers;

FIG. 2 is a diagram illustrating connection relationships between an apparatus for verifying cloud service compatibility, cloud service providers, and cloud service customers according to an embodiment of the present invention;

FIG. 3 is a configuration diagram of an apparatus for verifying cloud service compatibility according to an embodiment of the present invention;

FIG. 4 is a detailed configuration diagram of the cloud service description management unit shown in FIG. 3;

FIG. 5 is a detailed configuration diagram of the cloud service relationship analysis unit shown in FIG. 3;

FIG. 6 is a detailed configuration diagram of the schema mapping information management unit shown in FIG. 3;

FIG. 7 is a detailed configuration diagram of the interoperability verification unit shown in FIG. 3;

FIG. 8 is a detailed configuration diagram of the data portability verification unit shown in FIG. 3; and

FIG. 9 is a flowchart illustrating a method for verifying cloud service compatibility according to an embodiment of the present invention.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention. However, the present invention may be implemented in different forms and is not limited to the following embodiments.

It should be noted that components not related to the description of the present invention are omitted in the drawings so as to clearly describe the present invention, and the same reference numerals are used to designate the same or similar elements throughout the drawings.

In the present specification, it should be understood that terms such as “include” or “have” are merely intended to indicate that components are present, and are not intended to exclude the possibility that one or more components will be present or added unless a description to the contrary is specifically pointed out in context.

Hereinafter, an apparatus and method for verifying cloud service compatibility according to embodiments of the present invention will be described in detail with reference to the attached drawings.

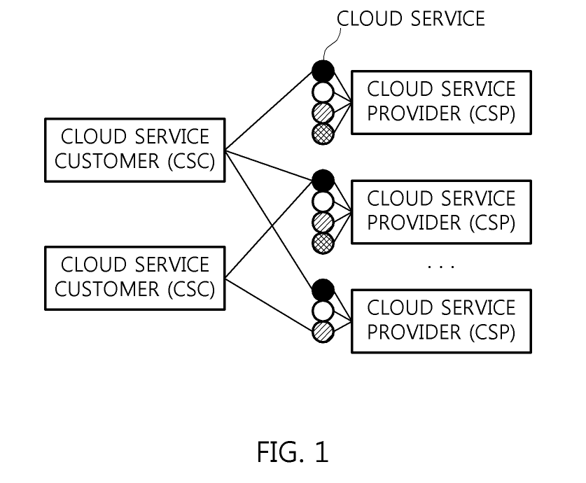

FIG. 1 is a diagram illustrating connection relationships between cloud service providers (CSP) and cloud service customers (CSC).

Referring to FIG. 1, a cloud system is configured such that cloud service providers are connected to cloud service customers (users) in order to provide cloud services, and thus each cloud service customer may enter into a contract for usage of a specific cloud service with a specific cloud service provider, and may use the specific cloud service provided by the specific cloud service provider with whom the contract was entered into.

In the present invention, the terms related to the cloud service are defined and used as follows. These definitions comply with the ISO/IEC 19941 which has been under development since 2014.

Interoperability: the ability to exchange information between two or more systems or applications and to use the information exchanged therebetween

Data portability: the ability to transfer information from one system to another system without re-inputting the information

Cloud interoperability: the ability of a cloud service customer to use a cloud service based on a method of exchanging information using a previously described scheme and of acquiring predicted results, or the ability of one cloud service to be linked to a cloud service provided by another cloud service provider (CSP)

Cloud data portability: the ability to transfer data from one cloud service to another cloud service

Cloud application portability: the ability to allow an application to migrate from one cloud service to another cloud service

The interoperability models in cloud computing are described as follows.

Policy interoperability: compatibility within the framework of laws, organizations and policies that are applicable to two or more systems

Pragmatic interoperability: the extent of matching between the intended usage of a service and the actual usage of the service

Semantic interoperability: the ability for data shared by systems that understand the concept of domains. The concept of domains in the cloud means the type of cloud service provision (e.g. infrastructure/platform/software)

Syntactic interoperability: the ability to exchange standardized information between two or more systems or services

Transport interoperability: a transport mechanism between cloud parties in the cloud (e.g. http/s, Simple Object Access Protocol (SOAP), . . . )

The data portability models in cloud computing are described as follows.

Policy data portability: the ability to transfer or copy data within the framework of laws, organizations, and policies that are applicable to two or more systems

Pragmatic data portability: the extent of matching between the intended usage of exchanged data and the actual usage of the exchanged data (data transferred from a CSP is used according to the intention thereof when being used by a CSC)

Semantic data portability: the ability to mutually understand a data model in a domain.

The term “data model” means data items, attributes, logical structures, and relationships between the data items

Syntactic data portability: the ability to receive data in a format understood by a receiver

The application portability models in cloud computing are described as follows.

Policy application portability: the right to use applications

Application behavior portability: the ability to execute an application which creates predicted results

Application instruction portability: the ability to execute a logical instruction set for applications and a combination of the applications

Application metadata portability: the ability to mutually understand the meaning of metadata about applications

Application syntactic portability: the ability to allow a receiver to receive applications and metadata in a form understood by the receiver

According to an embodiment of the present invention, interoperability and data portability in a cloud service may be used to have meanings included in the term “compatibility”.

Therefore, in the present invention, an apparatus for verifying cloud service compatibility may mean an apparatus capable of verifying cloud interoperability and data portability.

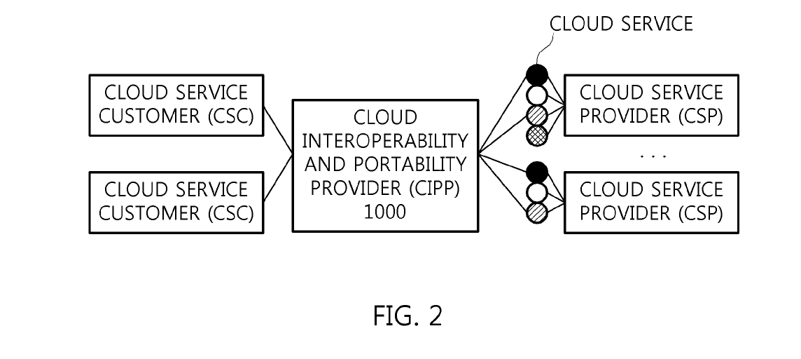

FIG. 2 is a diagram illustrating connection relationships between an apparatus 1000 for verifying cloud service compatibility (also referred to as a “cloud interoperability and portability provider (CIPP)”), cloud service providers, and cloud service customers according to an embodiment of the present invention.

Referring to FIG. 2, the connection between the cloud service compatibility verification apparatus 1000, the cloud service providers, and the cloud service customers in the cloud system is illustrated.

In accordance with an embodiment of the present invention, semantic and syntactic interoperability in a cloud service may mean interoperability between cloud service customers and cloud service providers and between cloud service providers, and portability may mean the migration of applications between the cloud service customers and the cloud service providers and the use of data without re-inputting the data.

In accordance with an embodiment of the present invention, methods of providing interoperability and portability for a cloud service may be chiefly classified into the following methods:

1) method of allowing a cloud service provider to provide cloud interoperability and portability

2) method of allowing a third-party business operator to provide cloud interoperability and portability

Method 1) allows the cloud service provider to completely support the provision of compatibility between cloud services, but there is a problem in that the cloud service provider considers only a cloud service thereof and does not consider even other cloud service providers.

Further, method 2) enables the provision of compatibility between cloud services provided by multiple cloud service providers, but there is a problem in that compatibility is inevitably limitedly provided to the cloud service providers under a subordinate relationship.

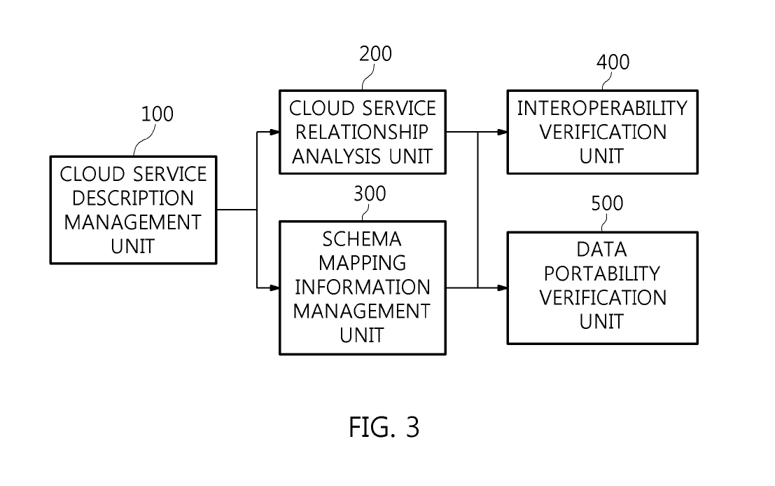

FIG. 3 is a configuration diagram of an apparatus for verifying cloud service compatibility according to an embodiment of the present invention.

Referring to FIG. 3, the cloud service compatibility verification apparatus 1000 may include a cloud service description management unit 100, a cloud service relationship analysis unit 200, a schema mapping information management unit 300, an interoperability verification unit 400, and a data portability verification unit 500.

The cloud service description management unit 100 may generate or update service description information by acquiring a cloud service description from at least one cloud service and parsing the acquired cloud service description.

Here, the term “cloud service description” may denote a descriptor for identifying cloud services that are provided, and describing information about details of the interfaces, service names, resources, etc. of the cloud services.

According to an embodiment of the present invention, the cloud service description may include a service description name, a category, a node location, an interface, a service, resource, binding information, a port, a programming language, price, a description, a service description creation date, service description version information, and a parent or child service name, but the cloud service description is not limited thereto, and any information related to cloud services may be used without restriction.

According to an embodiment of the present invention, a cloud service description that is used may include the contents given in the following Table 1.

TABLE 1

| Cloud service | |
|---|---|
| description name | Name for identifying cloud service description |
| Category | Classified into categories 1 to 3 |
| | e.g.: Interface, Service, Resource |
| Node location | Location of cloud service provided by cloud service provider |
| | e.g. described in URL |
| Interface | Interface (API) for cloud service and parameters thereof |
| | e.g. bucket interface (among Google cloud storage interfaces) |
| | DELETE /b/bucket |
| | GET /b/bucket |
| | POST /b |
| | GET /b |
| | PATCH /b/bucket |
| | PUT /b/bucket |
| | e.g. bucket delete interface (XML) among the above APIs |
| | DELETE / HTTP/1.1 |
| | Host: bucket.storage.googleapis.com |
| | Date: <date> |
| | Authorization: <authentication string> |
| | Content-Length: <request body length> |
| Service | Library for cloud service |
| | e.g., Amazon S3 |
| | com.amazonaws.services.s3 |
| | com.amazonaws.services.s3.event |
| | com.amazonaws.services.s3.iterable |
| | com.amazonaws.services.s3.metrics |
| | com.amazonaws.services.s3.model |
| | com.amazonaws.services.s3.transfer |
| | com.amazonaws.services.s3.transfer.exception |
| | com.amazonaws.services.s3.transfer.model |
| Resource | Classified into computing, storage, and network resources |
| Binding | Detailed protocols and data formats |
| | e.g. HTTP, XML |
| Port | Port number for binding |
| | e.g. 8080 |
| Programming | Language for binding |
| language | e.g. Java, Python, XML, HTML, C, etc. |
| Price | Expense for using service |
| | 10,000/M (10,000 Won per month) |
| Description | Information required in order to search for cloud service description |
| | (CSD) |
| Cloud service | Data at which cloud service description is created |
| description | |
| creation date | |
| Cloud service | Information about version of cloud service description |
| description version | |
| information | |
| Parent service | Cloud service description names of parent services in cloud service |
| | description |
| Child service | Cloud service description names of child services in cloud service |
| | description |

Here, the service description information may mean information that is generated using cloud service description information that is extracted from at least one cloud service description by parsing the cloud service description.

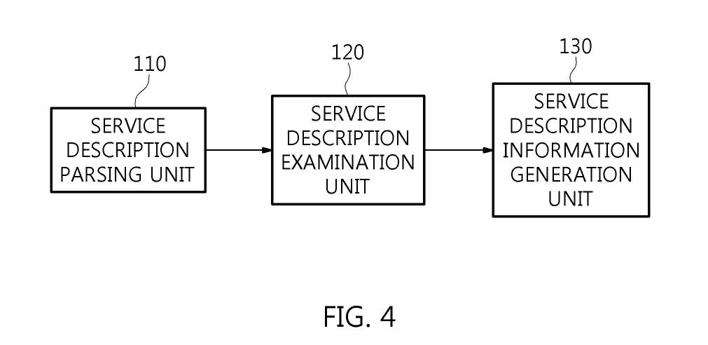

The cloud service description management unit 100 will be described in detail later with reference to FIG. 4.

The cloud service relationship analysis unit 200 may generate cloud service associative relationship information by searching for one or more cloud services that use the cloud service description included in the service description information and grouping the found one or more cloud services.

Here, the cloud service associative relationship information may mean information generated by grouping the results of searching multiple cloud services, which are provided using information about a cloud service description included in the service description information, for cloud services which use the corresponding cloud service description, depending on respective cloud service descriptions, and by acquiring information about associative relationships between the cloud services and the cloud service descriptions.

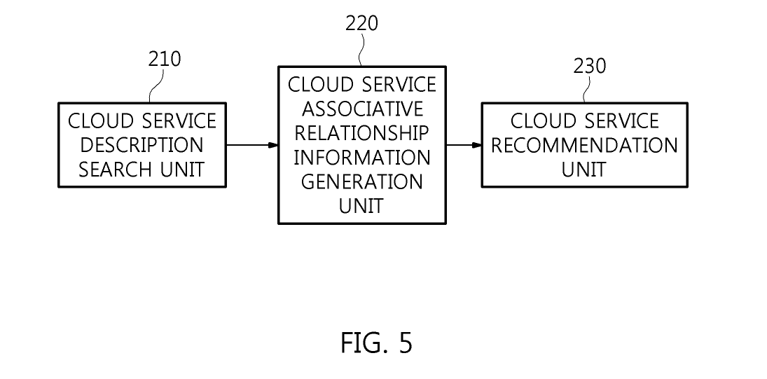

The cloud service relationship analysis unit 200 will be described in detail later with reference to FIG. 5.

The schema mapping information management unit 300 may manage user-defined functions to be used to verify data portability, may generate schema mapping information that includes corresponding relationships between respective components constituting a schema using data about the user-defined functions, and may convert data included in the service description information in consideration of the user-defined functions and the schema mapping information.

Here, the term “user-defined function” may mean a function required to examine portability between data models in a semantic data portability examination.

According to an embodiment of the present invention, the term “schema mapping information” may mean information that includes corresponding relationships between respective components (e.g. elements, attributes, tables, and columns) constituting each schema, and information corresponding to the user-defined functions.

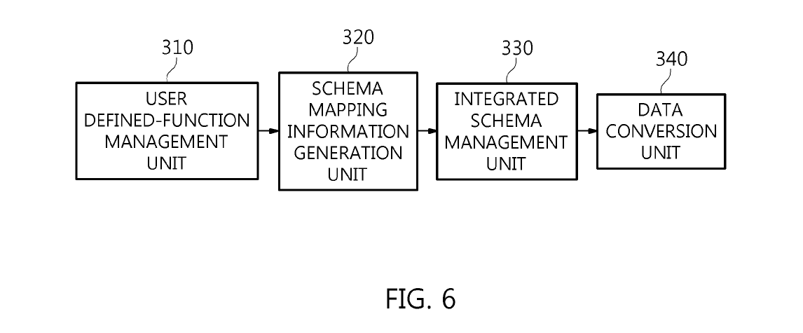

The schema mapping information management unit 300 will be described in detail later with reference to FIG. 6.

The interoperability verification unit 400 may determine whether one or more cloud services are interoperable with each other based on the cloud service associative relationship information and the converted schema data.

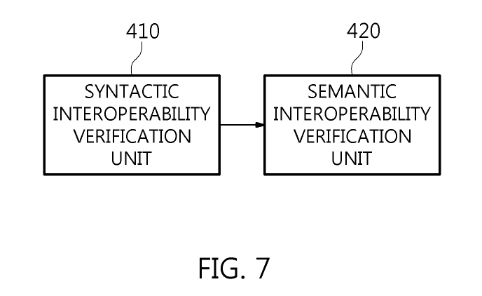

The interoperability verification unit 400 will be described in detail later with reference to FIG. 7.

The data portability verification unit 500 may determine whether pieces of data are mutually portable between the one or more cloud services based on the cloud service associative relationship information and the converted schema data.

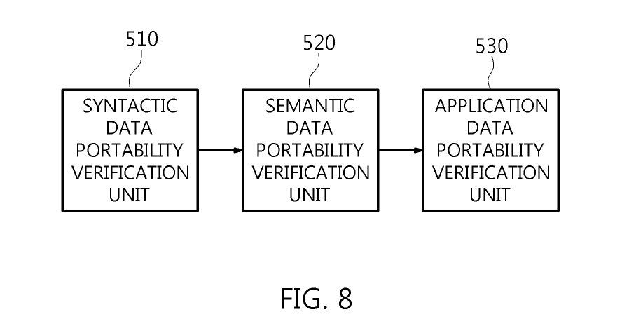

The data portability verification unit 500 will be described in detail later with reference to FIG. 8.

According to an embodiment of the present invention, the cloud service compatibility verification apparatus 1000 may further include a cloud service description database (DB) 600 for storing or updating the acquired cloud service description and the service description information.

According to an embodiment of the present invention, the cloud service compatibility verification apparatus 1000 may further include a schema DB for storing or updating the user-defined functions and the schema mapping information.

FIG. 4 is a detailed configuration diagram of the cloud service description management unit 100 shown in FIG. 3.

Referring to FIG. 4, the cloud service description management unit 100 may include a service description parsing unit 110, a service description examination unit 120, and a service description information generation unit 130.

The service description parsing unit 110 may parse a cloud service description provided in at least one data format.

According to an embodiment of the present invention, the data format is not limited to a specific data format, and any data format may be used without restriction as long as the data format may be provided in cloud services.

The service description examination unit 120 may examine the parsed cloud service description for the syntax of a service description language.

According to an embodiment of the present invention, the syntax of the service description language may be examined, and stored cloud service descriptions may be periodically examined.

The service description information generation unit 130 may generate or manage service description information that includes information about the parsed cloud service description and information about the results of the service description examination.

According to an embodiment of the present invention, the service description information generation unit 130 may provide a management function such as the function of storing, changing, or deleting cloud service descriptions.

FIG. 5 is a detailed configuration diagram of the cloud service relationship analysis unit 200 shown in FIG. 3.

Referring to FIG. 5, the cloud service relationship analysis unit 200 may include a cloud service description search unit 210 and a cloud service associative relationship information generation unit 220. According to another embodiment, the cloud service relationship analysis unit 200 may further include a cloud service recommendation unit 230.

The cloud service description search unit 210 may search for a cloud service description having the same format as that of the cloud service description included in service description information.

According to an embodiment of the present invention, the cloud service description search unit 210 may provide the function of searching for a cloud service description included in the service description information and searching for service descriptions having the same format as the cloud service description included in the service description information. For this, a keyword search, a directory search, or the like may be provided.

The cloud service associative relationship information generation unit 220 may search for one or more cloud services that use the found cloud service description, and may then generate cloud service associative relationship information indicative of associative relationships between the cloud service description and the found one or more cloud services by grouping the one or more cloud services.

According to an embodiment of the present invention, the cloud service associative relationship information generation unit 220 may group the found one or more cloud services, and may then generate cloud service associative relationship information indicative of associative relationships with cloud services, which include information enabling cloud services related to a single specific cloud service description to be found.

According to an embodiment of the present invention, the cloud service associative relationship information generated by the cloud service associative relationship information generation unit 220 may include information about items and details of cloud services having parent or child relationships therebetween.

The cloud service recommendation unit 230 may provide information about items and details of interoperable or data-portable cloud services to cloud services that match the acquired service description information based on the cloud service associative relationship information.

According to an embodiment of the present invention, the cloud service recommendation unit 230 may provide information about items and details of interoperable or data-portable cloud services to cloud services that match the cloud service associative relationship information or service description information of a cloud service personally input by the user (customer).

FIG. 6 is a detailed configuration diagram of the schema mapping information management unit 300 shown in FIG. 3.

Referring to FIG. 6, the schema mapping information management unit 300 may include a user defined-function management unit 310, a schema mapping information generation unit 320, an integrated schema management unit 330, and a data conversion unit 340.

The user defined-function management unit 310 may manage user-defined functions used for examination between data models to verify data portability.

According to an embodiment of the present invention, the user-defined function management unit 310 may store, change or delete the user-defined functions so as to manage the user-defined functions.

The schema mapping information generation unit 320 may generate mapping information that includes corresponding relationships between respective components constituting each schema based on the user-defined functions.

According to an embodiment of the present invention, the respective components constituting the schema may include elements, attributes, tables, columns, etc.

The integrated schema management unit 330 may integrate the schema of the corresponding data depending on schema mapping information, and may manage the schema by storing, searching or changing the integrated data.

According to an embodiment of the present invention, the integrated schema management unit 330 may integrate values or schemata when the integration of schema of the corresponding data is required when conforming to the schema mapping information.

According to a detailed embodiment, assuming that service “A” processes the names of persons, if last names and first names are divided, the last names and first names may be integrated into a single schema.

The data conversion unit 340 may convert the schema of the corresponding data in consideration of the user-defined functions and the schema mapping information.

According to an embodiment of the present invention, the data conversion unit 340 may convert the schema of the corresponding data either by using the user-defined functions or by executing rules included in the schema mapping information.

FIG. 7 is a detailed configuration diagram of the interoperability verification unit 400 shown in FIG. 3.

Referring to FIG. 7, the interoperability verification unit 400 may include a syntactic interoperability verification unit 410 and a semantic interoperability verification unit 420.

The syntactic interoperability verification unit 410 may determine whether respective Application Programming Interfaces (APIs) of cloud services are identical to each other at the API level by analyzing service description information based on cloud service associative relationship information and converted schema data, and may then verify interoperability between the cloud services.

According to an embodiment of the present invention, the syntactic interoperability verification unit 410 may verify syntactic interoperability in relation to whether one or more cloud services are interoperable with each other, based on service descriptions. Further, the syntactic interoperability verification unit 410 may determine whether the APIs of the cloud services are different from each other at the API level, and may then verify interoperability between the cloud services if it is determined that the APIs are different from each other.

The semantic interoperability verification unit 420 may verify whether pieces of data, which are provided for respective domains in infrastructure, a platform, and software of Infrastructure as a Service (IaaS), a Platform as a Service (PaaS), and Software as a Service (SaaS), are interoperable with each other, based on the cloud service associative relationship information and the converted schema data.

FIG. 8 is a detailed configuration diagram of the data portability verification unit 500 shown in FIG. 3.

The data portability verification unit 500 may include a syntactic data portability verification unit 510, a semantic data portability verification unit 520, and an application data portability verification unit 530.

The syntactic data portability verification unit 510 may verify whether the data formats of one or more cloud services are mutually portable based on cloud service associative relationship information and converted schema data.

According to an embodiment of the present invention, the syntactic data portability verification unit 510 may examine whether the data formats provided by cloud services of cloud service providers are formats that are interpretable by the terminal of a cloud service customer.

The semantic data portability verification unit 520 may verify whether cloud service data models of the one or more cloud services are mutually portable, based on the cloud service associative relationship information and the converted schema data.

According to an embodiment of the present invention, the semantic data portability verification unit 520 may allow cloud service providers and a cloud service customer to recognize the data models of one or more cloud services (data items, attributes, logical structures, and relationships between the data items) in the domains of infrastructure, a platform, and software, and may examine whether pieces of data are mutually portable between respective cloud services.

The application data portability verification unit 530 may verify whether pieces of metadata about applications used in the one or more cloud services are mutually portable, based on the cloud service associative relationship information and the converted schema data.

According to an embodiment of the present invention, the application data portability verification unit 530 may examine whether applications of the cloud services and pieces of metadata used in the applications have formats that are interpretable by the terminal of the cloud service customer.

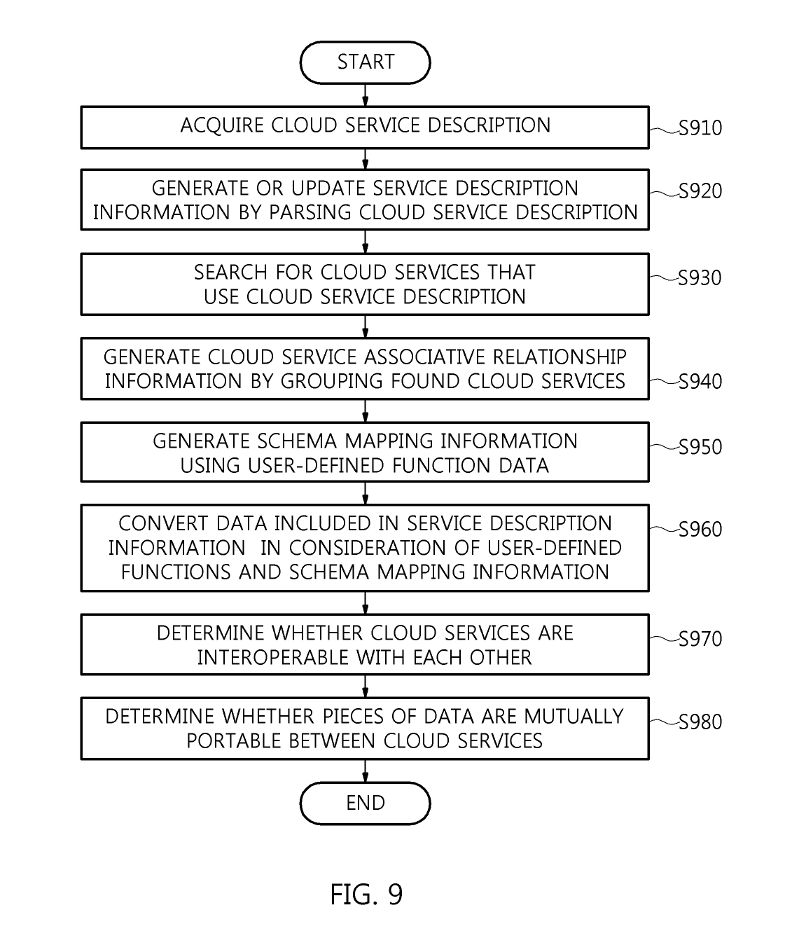

FIG. 9 is a flowchart illustrating a method for verifying cloud service compatibility according to an embodiment of the present invention.

A cloud service description is acquired at step 910.

According to an embodiment of the present invention, the cloud service description may be acquired from at least one cloud service.

Here, the term “cloud service description” may denote a descriptor for identifying cloud services that are provided, and describing information about details of the interfaces, service names, resources, etc. of the cloud services.

According to an embodiment of the present invention, the cloud service description may include a service description name, a category, a node location, an interface, a service, resource, binding information, a port, a programming language, price, a description, a service description creation date, service description version information, and a parent or child service name, but the cloud service description is not limited thereto, and any information related to cloud services may be used without restriction.

Service description information may be generated or updated by parsing the acquired cloud service description at step 920.

According to an embodiment of the present invention, a cloud service description provided in at least one data format may be parsed.

According to an embodiment of the present invention, the data format is not limited to a specific data format, and any data format may be used without restriction as long as the data format may be provided in cloud services.

According to an embodiment of the present invention, it is possible to examine the parsed cloud service description for the syntax of a service description language.

According to an embodiment of the present invention, the syntax of the service description language may be examined, and stored cloud service descriptions may be periodically examined.

According to an embodiment of the present invention, service description information that includes information about the parsed cloud service description and information about the results of the service description examination may be generated or managed.

According to an embodiment of the present invention, it is possible to provide a management function such as the function of storing, changing, or deleting cloud service descriptions.

One or more cloud services that use the cloud service description included in the service description information are searched for at step 930.

According to an embodiment of the present invention, it is possible to search for cloud service descriptions having the same format as that of the cloud service description included in the service description information.

According to an embodiment of the present invention, there can be provided the function of searching for a cloud service description included in the service description information and searching for service descriptions having the same format as the cloud service description included in the service description information. For this, a keyword search, a directory search, or the like may be provided.

Cloud service associative relationship information is generated by grouping the found one or more cloud services at step 940.

According to an embodiment of the present invention, it is possible to search for one or more cloud services that use the found cloud service description, and then generate cloud service associative relationship information indicative of associative relationships between the cloud service description and the found one or more cloud services by grouping the one or more cloud services.

According to an embodiment of the present invention, the found one or more cloud services may be grouped, and then cloud service associative relationship information indicative of associative relationships with cloud services, which include information enabling cloud services related to a single specific cloud service description to be found, may be generated.

According to an embodiment of the present invention, the cloud service associative relationship information may include information about items and details of cloud services having parent or child relationships therebetween.

According to an embodiment of the present invention, information about items and details of interoperable or data-portable cloud services may be provided to cloud services that match the acquired service description information based on the cloud service associative relationship information.

According to an embodiment of the present invention, information about items and details of interoperable or data-portable cloud services may be provided to cloud services that match the cloud service associative relationship information or service description information of a cloud service personally input by the user (customer).

Schema mapping information is generated using user-defined function data at step 950.

According to an embodiment of the present invention, user-defined functions used for examination between data models to verify data portability may be managed.

According to an embodiment of the present invention, it is possible to store, change or delete the user-defined functions so as to manage the user-defined functions.

According to an embodiment of the present invention, mapping information that includes corresponding relationships between respective components constituting each schema may be generated based on the user-defined functions.

According to an embodiment of the present invention, the respective components constituting the schema may include elements, attributes, tables, columns, etc.

The data included in the service description information is converted in consideration of the user-defined functions and the schema mapping information at step 960.

According to an embodiment of the present invention, the schema of the corresponding data may be integrated depending on schema mapping information, and the schema may be managed by storing, searching or changing the integrated data.

According to an embodiment of the present invention, values or schemata may be integrated when the integration of schema of the corresponding data is required when conforming to the schema mapping information.

According to a detailed embodiment, assuming that service “A” processes the names of persons, if last names and first names are divided, the last names and first names may be integrated into a single schema.

According to an embodiment of the present invention, the schema of the corresponding data may be converted in consideration of the user-defined functions and the schema mapping information.

According to an embodiment of the present invention, the schema of the corresponding data may be converted either by using the user-defined functions or by executing rules included in the schema mapping information.

Whether one or more cloud services are interoperable with each other is determined based on the cloud service associative relationship information and the converted schema data at step 970.

According to an embodiment of the present invention, it may be determined whether respective APIs of cloud services are identical to each other at the API level by analyzing service description information based on cloud service associative relationship information and converted schema data, and then interoperability between the cloud services may be verified. Thus, whether the one or more cloud services are interoperable with each other may be determined.

According to an embodiment of the present invention, it is possible to verify syntactic interoperability in relation to whether one or more cloud services are interoperable with each other, based on service descriptions. Further, it is also possible to determine whether the APIs of the cloud services are different from each other at the API level, and then verify interoperability between the cloud services if it is determined that the APIs are different from each other.

Whether pieces of data are mutually portable between the one or more cloud services is determined based on the cloud service associative relationship information and the converted schema data at step 980.

According to an embodiment of the present invention, it is possible to verify whether pieces of data, which are provided for respective domains in infrastructure, a platform, and software of IaaS, PaaS, and SaaS, are interoperable with each other, based on the cloud service associative relationship information and the converted schema data, and thus it may be determined whether pieces of data are mutually portable between the one or more cloud d services.

Embodiments of the present invention are not limitedly implemented using only the above-described apparatus and/or method. Although the embodiments of the present invention have been described in detail, those skilled in the art will appreciate that the scope of the present invention is not limited to those embodiments, and that various modifications and changes derived from the basic concept of the present invention defined by the accompanying claims also fall within the scope of the present invention.

What is claimed is:

1. An apparatus for verifying cloud service compatibility, comprising:
a cloud service description management unit for generating or updating service description information by acquiring a cloud service description from at least one cloud service and by parsing the acquired cloud service description;
a cloud service relationship analysis unit for generating cloud service associative relationship information by searching for one or more cloud services that use a cloud service description included in the service description information and by grouping the found one or more cloud services;
a schema mapping information management unit for managing a user-defined function to be used for verification of data portability, generating schema mapping information that includes corresponding relationships between respective components constituting each schema using data about the user-defined function, and converting data included in the service description information in consideration of the user-defined function and the schema mapping information;
an interoperability verification unit for determining whether the one or more cloud services are interoperable with each other based on the cloud service associative relationship information and converted schema data; and
a data portability verification unit for determining whether pieces of data are mutually portable between the one or more cloud services based on the cloud service associative relationship information and the converted schema data.

2. The apparatus of claim 1, wherein the cloud service description management unit comprises:
a service description parsing unit for parsing a cloud service description provided in at least one data format;
a service description examination unit for examining the parsed cloud service description for syntax of a service description language; and
a service description information generation unit for generating or managing service description information that includes information about the parsed cloud service description and information about results of the service description examination.

3. The apparatus of claim 1, wherein the cloud service relationship analysis unit comprises:
a cloud service description search unit for searching for a cloud service description having a format identical to that of the cloud service description included in the service description information; and
a cloud service associative relationship information generation unit for searching for one or more cloud services that use the found cloud service description, and generating cloud service associative relationship information indicative of associative relationships between the cloud service description and the found one or more cloud services by grouping the one or more cloud services.

4. The apparatus of claim 3, wherein the cloud service associative relationship information generation unit further comprises a cloud service recommendation unit for providing information about items and details of interoperable or data-portable cloud services to cloud services that match the acquired service description information based on the cloud service associative relationship information.

5. The apparatus of claim 3, wherein the cloud service associative relationship information generation unit includes information about items and details of cloud services having a parent or child relationship therebetween in the cloud service associative relationship information.

6. The apparatus of claim 1, wherein the schema mapping information management unit comprises:
a user-defined function management unit for managing the user-defined function by storing, changing or deleting a user-defined function used for examination between data models to verify data portability;
a schema mapping information generation unit for generating mapping information that includes corresponding relationships between respective components constituting each schema based on the user-defined function;
an integrated schema management unit for integrating a schema of corresponding data based on the schema mapping information, and managing the schema by storing, searching for or changing the integrated data; and
a data conversion unit for converting the schema of the corresponding data in consideration of the user-defined function and the schema mapping information.

7. The apparatus of claim 1, wherein the interoperability verification unit comprises:
a syntactic interoperability verification unit for determining whether respective Application Programming Interfaces (APIs) of the cloud services are identical to each other at an API level by analyzing the service description information based on the cloud service associative relationship information and the converted schema data, thus verifying interoperability between the cloud services; and
a semantic interoperability verification unit for verifying whether pieces of data, which are provided for respective domains in an infrastructure, a platform, and software of an Infrastructure as a Service (IaaS), a Platform as a Service (PaaS), and Software as a Service (SaaS), are interoperable with each other, based on the cloud service associative relationship information and the converted schema data.

8. The apparatus of claim 1, wherein the data portability verification unit comprises:
a syntactic data portability verification unit for verifying whether the data formats of the one or more cloud services are mutually portable, based on the cloud service associative relationship information and the converted schema data;
a semantic data portability verification unit for verifying whether cloud service data models of the one or more cloud services are mutually portable, based on the cloud service associative relationship information and the converted schema data; and
an application data portability verification unit for verifying whether pieces of metadata about applications used in the one or more cloud services are mutually portable, based on the cloud service associative relationship information and the converted schema data.

9. The apparatus of claim 1, further comprising a cloud service description database for storing or updating the acquired cloud service description and the service description information.

10. The apparatus of claim 1, further comprising a schema database for storing or updating the user-defined function and the schema mapping information.

11. The apparatus of claim 1, wherein the cloud service description comprises a service description name, a category, a node location, an interface, a service, resource, binding information, a port, a programming language, price, a description, a service description creation date, service description version information, and a parent or child service name.

12. A method for verifying cloud service compatibility, comprising:
generating or updating service description information by acquiring a cloud service description from at least one cloud service and by parsing the acquired cloud service description;
generating cloud service associative relationship information by searching for one or more cloud services that use a cloud service description included in the service description information and by grouping the found one or more cloud services;
managing a user-defined function to be used for verification of data portability, generating schema mapping information that includes corresponding relationships between respective components constituting each schema using data about the user-defined function, and converting data included in the service description information in consideration of the user-defined function and the schema mapping information;
determining whether the one or more cloud services are interoperable with each other based on the cloud service associative relationship information and converted schema data; and
determining whether pieces of data are mutually portable between the one or more cloud services based on the cloud service associative relationship information and the converted schema data.

13. The method of claim 12, wherein generating or updating the service description information comprises:
parsing a cloud service description provided in at least one data format;
examining the parsed cloud service description for syntax of a service description language; and
generating or managing service description information that includes information about the parsed cloud service description and information about results of the service description examination.

14. The method of claim 12, wherein generating the cloud service associative relationship information comprises:
searching for a cloud service description having a format identical to that of the cloud service description included in the service description information; and
searching for one or more cloud services that use the found cloud service description, and then generating cloud service associative relationship information indicative of associative relationships between the cloud service description and the found one or more cloud services by grouping the one or more cloud services.

15. The method of claim 14, wherein generating the cloud service associative relationship information further comprises providing information about items and details of interoperable or data-portable cloud services to cloud services that match the acquired service description information based on the cloud service associative relationship information.

16. The method of claiml4, wherein generating the cloud service associative relationship information is configured to include information about items and details of cloud services having a parent or child relationship therebetween in the cloud service associative relationship information.

17. The method of claim 12, wherein converting the data included in the service description information comprises:
managing the user-defined function by storing, changing or deleting a user-defined function used for examination between data models to verify data portability;
generating mapping information that includes corresponding relationships between respective components constituting each schema based on the user-defined function;
integrating a schema of corresponding data based on the schema mapping information, and managing the schema by storing, searching for or changing the integrated data; and
converting the schema of the corresponding data in consideration of the user-defined function and the schema mapping information.

18. The method of claim 12, wherein determining whether the one or more cloud services are interoperable with each other comprises:
determining whether respective Application Programming Interfaces (APIs) of the cloud services are identical to each other at an API level by analyzing the service description information based on the cloud service associative relationship information and the converted schema data, thus verifying interoperability between the cloud services; and
verifying whether pieces of data, which are provided for respective domains in an infrastructure, a platform, and software of an Infrastructure as a Service (IaaS), a Platform as a Service (PaaS), and Software as a Service (SaaS), are interoperable with each other, based on the cloud service associative relationship information and the converted schema data.

19. The method of claim 12, wherein determining whether the pieces of data are mutually portable comprises:
verifying whether the data formats of the one or more cloud services are mutually portable, based on the cloud service associative relationship information and the converted schema data;
verifying whether cloud service data models of the one or more cloud services are mutually portable, based on the cloud service associative relationship information and the converted schema data; and
verifying whether pieces of metadata about applications used in the one or more cloud services are mutually portable, based on the cloud service associative relationship information and the converted schema data.

20. The method of claim 12, further comprising storing or updating the acquired cloud service description and the service description information.
